(19) United States
(12) Patent Application Publication
(10) Pub. No.: US 2019/0284398 A1
(43) Pub. Date: Sep. 19, 2019

(54) Silicate coatings

(71) Applicant: STO SE & Co. KGaA, Stuhlingen (DE)

(72) Inventors: Michael Troll, Bonndorf-Dillendorf (DE); Jack van Leeuwen, Zofingen (CH); Gerald Burgeth, Eggingen (DE)

(21) Appl. No.: 16/285,756

(22) Filed: Feb. 26, 2019

Related U.S. Application Data
(60) Provisional application No. 62/642,853, filed on Mar. 14, 2018.

(51) Int. Cl. C09D 1/06; C09D 7/63; C09D 7/61; C09D 5/02; C01B 33/24; C09D 1/04; C09D 7/65; C08L 33/02

(52) U.S. Cl. CPC C09D 1/06; C09D 7/63; C09D 7/61; C09D 5/028; C08K 2003/0881; C09D 1/04; C09D 7/65; C08L 33/02; C01B 33/24

(57) ABSTRACT

The invention concerns a silicate coating, comprising at least one basic silicate, at least one filler and/or pigment, at least one water-soluble carbohydrate, water in order to produce a liquid or pasty consistency, optionally at least one organic binder, and optional conventional additives.

### RELATED APPLICATION

This application claims priority to U.S. Provisional application Ser. No. 62/642,853, filed on Mar. 14, 2018, the entire contents of which are hereby incorporated by reference.

The invention relates to silicate coatings, especially silicate paints and dispersion silicate paints, comprising at least one basic silicate, at least one filler and/or pigment, water in order to produce a pasty consistency, optionally at least one organic binder, and optional conventional additives.

### TECHNICAL FIELD OF THE INVENTION

Silicate paints are a very important special case of silicate mineral paints. As described in detail in Wikipedia, for example, in addition to inorganic colorants as the main component, they contain a potassium-containing alkali silicate, also known as water glass. A coating with silicate paints binds itself irresolvably to the substrate by silicification. The result is an extremely resistant bond between the coating and the coating support. In addition, the water glass binder is highly resistant to the effects of UV. Under the effects of UV, organic binders such as acrylate or silicone resin dispersions become brittle and chalking effects appear as well as cracks which result in damage to the coating over the years, while the inorganic water glass binder remains stable. The chemical bond with the substrate and the UV stability of the binder are the essential reasons for the extraordinarily long service life of silicate paints.

In order to set, silicate paints require a mineral base containing silicon. Thus, they are suitable for mineral substrates such as mineral renders and concrete.

Silicate paints are enormously colourfast. Because they have been coloured exclusively with mineral pigments and the colours of these latter are not modified by UV light, the colour of silicate coatings remains constant for decades.

In principle, historically, three types of silicate paints can be distinguished, although their definitions should not limit the invention:

Pure silicate paints consist of two components, a colour powder which is dry or can be made into a paste with water, and the liquid water glass binder. Application requires a lot of skill and know-how. It is particularly widely used in historic fields. In contrast to this, silicate paints in accordance with the invention may comprise other components.

The first single-component silicate paint was developed in the middle of the 20th century. By adding up to 5% by weight of organic additives (for example acrylate dispersion, hydrophobicity agent, thickener or the like), the ready-to-use paint can be provided in a bucket. These are what are known as “dispersion silicate paints”. Compared with pure silicate paint, the range of applications of these types of silicate paints is substantially larger, because even substrates with low strengths and/or organic components can be coated. In addition, application is easier than with pure silicate paint. Dispersion silicate paints in accordance with the invention may comprise more than 5% by weight of organic additives, in particular binders.

A third category of silicate paints, what are known as sol silicate paints, has existed since 2002. They contain a combination of silica sol and water glass as the binder. The organic fraction is limited to 5% by weight, as is the case with dispersion silicate paints, in order to obtain chemical setting and strengthening typical of silicates. Sol silicate paints can also be used on non-mineral renders. Here, binding is chemical and physical. These paints can be applied easily and safely to almost all conventional substrates.

Known silicate and dispersion silicate coatings should (also) be suitable for use on absorbent, mineral and/or basic, cementitious substrates. However, silicate-bonded coatings of this type have significant weaknesses. On critical substrates (for example absorbent, mineral and/or basic, cementitious substrates), drying of the silicate-bonded coating occurs too quickly because the silicification reaction is accelerated by the basicity of the substrate. After the silicate binder comes into contact with the basic substrate, an immediate reaction of the silicate binder takes place with the “reactive” components of the substrate (Ca(OH)₂, other basic silicates and/or (siliceous) fillers with surface OH groups). This silicification reaction starts immediately, and so penetration into the substrate is compromised.

Critical substrates, in particular basic absorbent substrates, are often not homogeneously critical or absorbent. Sites or regions exist which are critical or absorbent to a greater or lesser extent. This leads to spotting if the substrate is not “homogenised” by pre-treatment (priming and/or fluating). “Fluating” is the neutralisation and hardening of alkaline substrates by application of a fluate, which is a salt of hexafluorosilicic acid (fluorosilicates).

When using silicate coatings or dispersion silicate coatings on old purely polymer-bonded coatings, problems also arise with adhesion, unless the substrate has been appropriately pre-treated. Silicification with the substrate cannot take place.

In this light, an essential objective of the invention is to provide silicate coatings which can dry without spotting on critical substrates, without the need for a pre-treatment of the substrate (priming and/or fluating).

These silicate coatings should be able to be applied as easily as comparable conventional silicate paints or dispersion silicate paints.

Dispersion silicate paints and other dispersion silicate coatings are aqueous, liquid or pasty mixtures prior to their intended use. Between manufacturing them and using them, they often have to withstand periods of weeks or months of storage, during which they must not change significantly. Because of the amount of organic binder which is in an aqueous medium, there is a risk that the compositions could be attacked by microbes which feed off the binder and other organic additives. This could render the affected composition useless and therefore has to be effectively prevented.

Thus, a further objective of the invention is to provide silicate coatings which are effectively protected against microbial attack.

The combinations of features of the accompanying independent patent claims achieve these and other objectives of the invention.

Advantageous further developments and embodiments of the invention are defined in the dependent claims.

### Definitions

In the context of the invention, “basic silicates” are silicates which react in a y alkaline manner upon contact with H₂O because of the presence, on the surface of the silicates, of at least one base function with a base strength of less than 5 (pKb<5). The “basic silicates” include basic alkali and alkaline-earth silicates.

Basic silicates contain at least one of the following basic groups or ions on the surface:
free oxide ions (O²⁻), pK_{b}=−15
free hydroxide ions (OH), pK_{b}=−1.8

Orthosilicate Groups or Ions:

| | |
|---|---|
| SiO₄⁴⁻ | pK_{b} = 0 |
| HSiO₄³⁻ | pK_{b} = 1 or SiO₄³⁻ groups |
| H₂SiO₄²⁻ | pK_{b} = 2.2 or SiO₄²⁻ groups |
| H₃SiO₄⁻ | pK_{b} = 4.3 or SiO₄⁻ groups |

Metasilicate Groups or Ions:

| | |
|---|---|
| SiO3²⁻ | pK_{b} = 2.2 |
| HSiO₃⁻ | pK_{b} = 4.5 or SiO₃⁻ groups |

Unless expressly stated otherwise, in the context of the invention, a coating, composition, paint, render and the like means both the product before it has been applied as well as the product after it has been applied.

The term “silicate paint” or “silicate coating” therefore encompasses the aqueous liquid or pasty coating composition prior to its application, as well as the solid coating which is dry to a greater or lesser extent that is produced by the application.

In the context of the invention, a “silicate coating” comprises a liquid or pasty composition which can be produced from a colour powder which is dry or has been made into a paste with water, and a basic silicate, such as water glass in particular, as the liquid binder, as well as the additives in accordance with the invention, in particular to retard setting, corresponding to the definition in patent claim 1.

In the context of the invention, a “dispersion silicate coating” comprises a single-component silicate coating with organic additives (for example acrylate dispersion, hydrophobicity agent, thickener or the like) and additives in accordance with the invention, in particular to retard setting, corresponding to the definition in patent claim 1.

In the context of the invention, a “sol silicate coating” is a silicate coating or dispersion silicate coating in accordance with the invention as defined above, corresponding to the definition in patent claim 1, but containing a combination of silica sol and water glass as the binder. The organic component is the same as that for the dispersion silicate coating in accordance with the invention.

In the context of the invention, silicate paints and dispersion silicate paints as well as similar silicate-containing compositions (for example sol silicate paints, coatings other than paints) and emulsion paints with an addition of basic silicates are also collectively referred to as “silicate coatings”. The terms “coating” and “composition” are in principle synonymous.

The invention also encompasses compositions the silicate content of which deviates from the usual silicate compositions. Thus, the invention also encompasses compositions with, compared with conventional (for example the aforementioned) compositions or coatings, substantially smaller silicate contents, in particular basic silicates, and substantially higher contents of at least one organic binder. The content of organic binder may be substantially more than 5% by weight and exceed or even greatly exceed the silicate content. Compositions of this type correspond to dispersion coatings with a supplement of basic silicates as an additive.

The percentages given are percentages by weight, unless stated otherwise.

### DETAILED DESCRIPTION OF THE INVENTION

The invention solves the problem of spot or streak formation when applying silicate coatings onto absorbent and/or strongly alkaline substrates, primarily by retarding the silicification reaction. This retardation is carried out by adding a water-soluble carbohydrate to the silicate coating before it has been applied.

Thus, the invention concerns silicate coatings, especially silicate paints, comprising at least one basic silicate, at least one filler and/or pigment, at least one water-soluble carbohydrate, water in order to produce a pasty consistency, optionally at least one organic binder, and optional conventional additives.

When using silicate coatings or dispersion silicate coatings on old purely polymer-bonded coatings, problems also arise with adhesion, unless the substrate has been appropriately pre-treated. Silicification with the substrate cannot take place. Because of the high organic polymer binder fraction and with a relatively low basic silicates fraction, appropriate embodiments of the coating compositions in accordance with the invention can also be applied to such substrates without problems.

Thus, if the occasion arises, there would be no need for complicated substrate treatment, either on absorbent alkaline substrates or on substrates which cannot undergo silicification.

In the context of the invention, in preferred embodiments of the invention, the basic silicate is an alkaline-earth silicate, in particular calcium silicate, for example cement, cement clinker, granulated slag and/or hydraulic lime, and/or an alkali silicate, for example lithium, sodium or potassium water glass. Particularly preferred embodiments of the invention contain both alkaline-earth silicate as well as alkali silicate.

When manufacturing the compositions in accordance with the invention, in the case of the alkaline-earth silicates, the basic silicate is used as the hydrate-free silicate, i.e. free or at least substantially free from alkaline-earth or calcium silicate hydrate (CSH) phases. This is understood not just by the person skilled in the art to mean that the alkaline-earth silicates or the materials containing alkaline-earth silicates, such as cement, are used in the non-set condition. CSH phases may be detected in a known manner, for example using X-ray diffraction.

Hydrate-free calcium silicates are components of cement clinker or of cement. In the context of the invention, the terms “cement clinker” (abbreviated to clinker) and “cement” are frequently used synonymously, but more correctly, it should be noted that cement clinker is the fired component of cement which is responsible for setting with the addition of water and which carries the basic silicates.

Cement is manufactured by grinding cement clinker with Ca sulphates. Cement clinkers are manufactured by sintering limestone, clay (marl) and quartz sand at high temperatures.

Clinker primarily consists of the following phases:

tricalcium silicate (alite), abbreviated in construction chemistry to C3S (3 CaO*SiO₂)

dicalcium silicate (belite), abbreviated to C2S (2 CaO*SiO₂)

tricalcium aluminate, abbreviated to C3A (3 CaO*Al₂O₃)

tetracalcium aluminate ferrite, abbreviated to C4AF or C4(A,F) (4 CaO*Al₂O₃*Fe₂O₃) and C2(A,F).

The simplified chemical reactions of the main clinker phase with mixing water to form calcium silicate hydrate can be written as follows:

2C3S+6H→CSH+3CH

written in full:

2(3 CaO*SiO₂)+6 H₂O→3 CaO*2 SiO₂*3 H₂O+3 Ca²⁺+6 OH⁻

In the invention, the calcium silicate phases are of particular interest, because they cause the substantial rise in pH when mixed with water. The aluminate phases as well as the CaO are of less interest, because their reaction is not as basic as the hydrate-free silicates. This means that cements and clinkers which have a particularly high basic silicate content (more C2S phases than C3S phases) are of great significance, because this basic silicate contributes substantially more to raising the pH than CaO. It is the stronger base.

Silicate-“rich” cements and clinkers with a SiO₂ fraction of more than 10%, preferably >15% and more preferably >20%, are preferred.

However, the SiO₂ fraction must also not be too high and should be below 50%, preferably below 40%, more preferably below 30%. Otherwise, the cement condenses too quickly and is then difficult to retard.

Thus, not only can cement and clinker act as a source of the calcium silicate phases, but granulated slag (slad sand) can as well; as a rule, this consists of approximately 30-45% CaO, 30-45% SiO₂, 5-15% Al₂O₃, 4-17% MgO, 0.5-1% S and traces of other elements.

Granulated slag is highly suitable, not only because of the high SiO₂ content, but especially also because of the fact that granulated slag is a latent hydraulic binder. “Latent” means that granulated slag is relatively inert and does not set quickly. Because setting of the hydraulic additive is not desired, granulated slag is highly suitable. However, it is substantially more expensive than cement/cement clinker. For reasons of cost, when using cement, the use of Portland cement, white cement or corresponding composite cements is preferred.

In the broadest embodiment, alkali silicates (Li, Na, K water glass, silica sols) and/or the hydrate-free alkali silicates (solid water glass) may be used as the basic silicates.

The basic silicate preferably comprises a hydrate-free alkaline-earth silicate, preferably calcium silicate (tricalcium silicate (alite, 3 CaO*SiO₂), dicalcium silicate (belite, 2 CaO*SiO₂). Particularly preferably, the alkaline-earth silicate entirely consists of calcium silicate.

The basic silicate also preferably comprises an alkali silicate, in particular water glass.

In preferred embodiments, the basic silicate comprises both alkaline-earth and alkali silicate.

In preferred embodiments, the basic silicate content is a maximum of 6% by weight, preferably at least 0.01% by weight, more preferably between 0.01 and 4% by weight, yet more preferably between 0.01 and 2% by weight, still more preferably between 0.01 and 1% by weight, especially between 0.05 and 0.5% by weight, with respect to the total weight of the composition.

In preferred embodiments, the substance which retards the setting or silicification of the basic silicate is a water-soluble carbohydrate which is preferably selected from saccharides such as, in particular, mono-, di- and oligo-saccharides, especially from sugars, amino sugars and deoxy sugars. Mono- and di-saccharides as well as household sugar (saccharose) and/or glucosamine are particularly preferred. Furthermore, hydroxycarboxylic acids such as, in particular, saccharic acids and their salts and derivatives may be used. Polysaccharides such as starch as well as other carbohydrates which are used in the prior art as thickeners are less suitable or even unsuitable as setting retardants due to their poor solubility.

Preferred embodiments of the invention have a content of a maximum of 1,0% by weight, preferably at least 0.001% by weight, more preferably between 0.005% by weight and 0.5% by weight, yet more preferably between 0.005% by weight and 0.1% by weight and most preferably between 0.01% by weight and 0.08% by weight of at least one water-soluble carbohydrate, with respect to the total weight of the composition.

Preferred embodiments of the invention have a content of at least one organic binder of between 1% by weight and 40% by weight, preferably between 2% by weight and 30% by weight, particularly preferably between 2.5% by weight and 25% by weight, respectively calculated as a solid.

Preferably, compositions in accordance with the invention comprise a content of at least one filler and/or pigment of between 10% by weight and 90% by weight, preferably between 20% by weight and 85% by weight, particularly preferably between 25% by weight and 80% by weight.

The water content of the composition is preferably between 5% by weight and 50% by weight.

The at least one organic binder is preferably selected from the group which comprises homopolymers, copolymers or terpolymers of acrylic acid and/or methacrylic acid, itaconic acid as well as acid esters such as ethyl acrylate, butyl acrylate; styrene, substituted or unsubstituted vinyl chloride, vinyl acetate, vinyl propionate, ethylene, butadiene, versatate, acrylamide and acrylonitrile; water-soluble alkyd polymers, combinations of (meth)acrylic/alkyd polymers, polyvinyl alcohol and mixtures thereof, wherein homopolymers or copolymers of acrylic acid and/or methacrylic acid are preferred, Aqueous polymer dispersions which are sufficiently stable to saponification are generally preferred.

The at least one filler or pigment is preferably selected from the group which comprises pyrogenic precipitated silica, precipitated silica, silicon-aluminium mixed oxides, alkaline-earth carbonates such as calcium carbonate, silicon dioxide, silicates, for example aluminosilicates, sulphates, such as barium sulphate, titanium dioxide, color pigments, for example iron oxide, bismuth vanadate or mixtures thereof, wherein titanium dioxide, silicates and carbonates are preferred.

Preferably, compositions in accordance with the invention contain at least one additive such as, for example, a rheological additive, a defoaming agent, a hydrophobicity agent, a wax or a wax preparation, a stabilizer, fibres, a film-forming agent and a dispersant and wetting agent.

The compositions in accordance with the invention may advantageously be used in order to produce a render, a paint, in particular an emulsion paint, a decorative final coating or the like.

Exemplary Embodiment 1: Emulsion Paint:

| | | |
|---|---|---|
| water | 28 | parts by weight |
| aqueous polymer dispersion (approx. 50% | 30 | parts by weight |
| solid content) | | |
| fillers and pigments | 37 | parts by weight |
| basic silicates | 0.5 | parts by weight |
| sugar | 0.05 | parts by weight |
| additives (in particular rheological additives, | 5 | parts by weight |
| hydrophobicity agents, defoaming agents, | | |
| film-forming agents, fibres, dispersants, etc) | | |

The pH of this paint formulation was 11.6; after 16 weeks, it was in fact 11.7.

Exemplary Embodiment 2: Dispersion Silicate Paint:

| | | |
|---|---|---|
| water | 31 | parts by weight |
| aqueous polymer dispersion (approx. 50% | 9 | parts by weight |
| solid content) | | |
| fillers and pigments | 52 | parts by weight |
| basic silicates | 4 | parts by weight |
| sugar | 0.08 | parts by weight |
| additives (in particular rheological additives, | 3.5 | parts by weight |
| hydrophobicity agents, defoaming agents, | | |
| film-forming agents, fibres, dispersants, etc) | | |

The pH of this paint formulation was 11.2; after 16 weeks, it was in fact 11.3.

Exemplary Embodiment 3: Dispersion Silicate Paint:

| | | |
|---|---|---|
| water | 33 | parts by weight |
| aqueous polymer dispersion (approx. 50% | 8 | parts by weight |
| solid content) | | |
| fillers and pigments | 54 | parts by weight |
| basic silicates | 1.5 | parts by weight |
| sugar | 0.05 | parts by weight |
| additives (in particular rheological additives, | 4 | parts by weight |
| hydrophobicity agents, defoaming agents, | | |
| film-forming agents, fibres, dispersants, etc) | | |

The pH of this paint formulation was 11.1; after 16 weeks, it was still 11.0.

The rheological properties (viscosity) during this time period remained practically unchanged. No microbial attack could be detected sensorially. The emulsion paint had been shown to be storage-stable.

Comparative Tests:

A commercial cementitious reinforcement mass was applied to fibre-cement plates. After drying for 24 hours under normal conditions, half of the test pieces were also treated with a commercial primer. After a further 24 hours, the paint coatings from exemplary embodiments 1, 2 and 3 as well as a commercial dispersion silicate paint and an emulsion paint were applied to all of the test pieces in a reproducible manner. Prior to this, the pH of the surfaces of the reinforcement layer was determined using indicator paper. The pH was approximately 11 in all cases. 48 hours later, the paint coatings of the test pieces were subjectively assessed as regards spot formation or the homogeneity of the surface, wherein “5” represented a perfect, very homogeneous appearance without spot formation and “1” represented clearly visible spot formation and a non-homogeneous appearance.

| | Test piece without | Test piece with |
|---|---|---|
| Paint coating | primer | primer |
| Exemplary embodiment 1 | 5 | 5 |
| Exemplary embodiment 2 | 4 | 5 |
| Exemplary embodiment 3 | 4 | 4 |
| Dispersion silicate paint | 1 | 2 |
| Emulsion paint | 5 | 5 |

The coating compositions in accordance with the invention combine the advantages of silicate coatings or dispersion silicate coatings with those of pure dispersion coatings without suffering from the disadvantages of the other type.

Thus, in a similar manner to silicate coatings, the coating compositions in accordance with the invention are resistant to contamination and fouling and also consolidate the substrate by slow silicification.

What is claimed is:

1. A silicate coating, comprising at least one basic silicate, at least one filler and/or pigment, at least one water-soluble carbohydrate, water in order to produce a liquid or pasty consistency, optionally at least one organic binder, and optional conventional additives.

2. The composition as claimed in claim 1,
characterized in that the basic silicate comprises an alkaline-earth silicate, preferably calcium silicate.

3. The composition as claimed in claim 1, characterized in that the alkaline-earth silicate is in the form of a cement in which preferably, the proportion of SiO₂ is more than 10%, preferably >15%, more preferably >20%, and preferably less than 50%, more preferably less than 40%, yet more preferably less than 30%.

4. The composition as claimed in claim 1,
characterized in that the basic silicate comprises an alkali silicate, preferably water glass.

5. The composition as claimed in claim 1,
characterized in that the basic silicate content is a maximum of 6% by weight, preferably at least 0.01% by weight, more preferably between 0.01 and 4% by weight, yet more preferably between 0.01% by weight and 2% by weight, more preferably between 0.01 and 1% by weight, especially between 0.05% by weight and 0.5% by weight, with respect to the total weight of the composition.

6. The composition as claimed in claim 1,
characterized in that the water-soluble carbohydrate is selected from saccharides such as, in particular, mono-, di- and oligo-saccharides, especially from sugars, amino sugars and deoxy sugars, particularly preferably from mono- and di-saccharides as well as household sugar (saccharose) and/or glucosamine; and from hydroxycarboxylic acids such as, in particular, saccharic acids and their salts and derivatives.

7. The composition as claimed in claim 6,
characterized in that the carbohydrate comprises household sugar and/or glucosamine.

8. The composition as claimed in claim 1,
characterized by a content of a maximum of 1.0% by weight, preferably at east 0.001% by weight, more preferably between 0.005% by weight and 0.5% by weight, yet more preferably between 0.005% by weight and 0.1% by weight and most preferably between 0.01% by weight and 0.08% by weight of water-soluble carbohydrate, with respect to the total weight of the composition.

9. The composition as claimed in claim 1,
characterized by a content of at least one organic binder of between 1% by weight and 40% by weight, preferably between 2% by weight and 30% by weight, particularly preferably between 2.5% by weight and 25% by weight, respectively calculated as a solid.

10. The composition as claimed in claim 1,
characterized by a content of at least one filler and/or pigment of between 10% by weight and 90% by weight, preferably between 20% by weight and 85% by weight, particularly preferably between 25% by weight and 80% by weight.

11. The composition as claimed in claim 1,
characterized by a water content of between 5% by weight and 50% by weight.

12. The composition as claimed in claim 1,
characterized by a content of at least one organic binder selected from the group which comprises homopolymers, copolymers or terpolymers of acrylic acid and/or methacrylic acid, itaconic acid as well as acid esters such as ethyl acrylate, butyl acrylate; styrene, substituted or unsubstituted vinyl chloride, vinyl acetate, vinyl propionate, ethylene, butadiene, versatate, acrylamide and acrylonitrile; water-soluble alkyd polymers, combinations of (meth)acrylic/alkyd polymers, polyvinyl alcohol and mixtures thereof, wherein homopolymers or copolymers of acrylic acid and/or methacrylic acid are preferred.

13. The composition as claimed in claim 1,
characterized by a content of at least one filler or pigment selected from the group which comprises pyrogenic precipitated silica, precipitated silica, silicon-aluminium mixed oxides, alkaline-earth carbonates such as calcium carbonate, silicon dioxide, silicates, for example aluminosilicates, sulphates, such as barium sulphate, titanium dioxide, color pigments, for example iron oxide, bismuth vanadate or mixtures thereof, wherein titanium dioxide, silicates and carbonates are preferred.

14. The composition as claimed in claim 1,
characterized by a content at least one additive such as, for example, a rheological additive, a defoaming agent, a hydrophobicity agent, fibres, a film-forming agent and a dispersant.

15. The composition as claimed in claim 1,
characterized in that the composition is a render, a paint, in particular an emulsion paint, a decorative final coating or the like.
